(19) United States
(12) Patent Application Publication
(10) Pub. No.: US 2021/0286046 A1
(43) Pub. Date: Sep. 16, 2021

(54) ROTATION SYSTEM AND SENSOR

(71) Applicant: SZ DJI TECHNOLOGY CO., LTD., Shenzhen (CN)

(72) Inventor: Wenkang ZHANG, Shenzhen (CN)

(21) Appl. No.: 17/337,409

(22) Filed: Jun. 2, 2021

Related U.S. Application Data
(63) Continuation of application No. PCT/CN2018/119245, filed on Dec. 4, 2018.

(51) Int. Cl. G01S 7/02

(52) U.S. Cl. CPC G01S 7/02; H04W 84/12

(57) ABSTRACT

A sensor includes a rotation system and a sensing member. The rotation system includes a rotation assembly, an electromagnetic induction power supply assembly, and a wireless communication assembly. The rotation assembly includes a fixing member and a rotation member. The electromagnetic induction power supply assembly includes a power transmission assembly mounted at the rotation member, and a power reception assembly mounted at the fixing member and configured to transmit power to the power reception assembly. The wireless communication assembly includes first and second signal assemblies mounted at the fixing member and the rotation member, respectively. The sensing member is mounted at the rotation member and is electrically coupled to the power reception assembly and the second signal assembly, and is configured to be powered by the power reception assembly and transmit sensing data through the first and second signal assemblies.

### CROSS-REFERENCE TO RELATED APPLICATION

This application is a continuation of International Application No. PCT/CN2018/119245, filed Dec. 4, 2018, the entire content of which is incorporated herein by reference.

### TECHNICAL FIELD

The present disclosure relates to the technical field of wireless transmission and, more particularly, to a rotation system and a sensor.

### BACKGROUND

Some existing rotation devices, such as rotation radar, have both communication and power transmission needs. In some rotation radars, a wired power supply mode and a wired transmission mode are employed currently.

Due to limitation of power supply cable and transmission cable, rotation angle of motor is restricted by cable twist, so that the rotation device cannot achieve 360° omni-directional rotation, and can only rotate within a certain range. For example, a rotation angle interval may be +270° to −270°. If the omni-directional rotation is required, rotation direction needs to be reversed alternately, which causes the motor to start and stop continuously, resulting in large start-stop power consumption and mechanical vibration, so that service life of the rotation device is reduced and application scenario of the rotation device is limited.

### SUMMARY

In accordance with the disclosure, there is provided a sensor including a rotation system and a sensing member. The rotation system includes a rotation assembly, an electromagnetic induction power supply assembly, and a wireless communication assembly. The rotation assembly includes a fixing member and a rotation member. The electromagnetic induction power supply assembly includes a power transmission assembly mounted at the rotation member, and a power reception assembly mounted at the fixing member and configured to transmit power to the power reception assembly. The wireless communication assembly includes first and second signal assemblies mounted at the fixing member and the rotation member, respectively. The sensing member is mounted at the rotation member and is electrically coupled to the power reception assembly and the second signal assembly, and is configured to be powered by the power reception assembly and transmit sensing data through the first and second signal assemblies.

### BRIEF DESCRIPTION OF THE DRAWINGS

In order to explain the embodiments of the present disclosure, reference is made to the accompanying drawings, which are used in the description of the embodiments or the existing technology. Obviously, the drawings in the following description are some embodiments of the present disclosure, and other drawings can be obtained from these drawings without any inventive effort for those of ordinary skill in the art.

FIG. 1 is a schematic structural diagram of a rotation system according to an embodiment of the present disclosure.

FIG. 2 is a schematic structural diagram of a circuit in a rotation system according to an embodiment of the present disclosure.

### DETAILED DESCRIPTION OF THE EMBODIMENTS

In order to make the objectives, technical solutions, and advantages of the embodiments of the present disclosure clearer, the technical solutions in the embodiments of the present disclosure will be clearly and completely described in combination with the accompanying drawings. Obviously, the described embodiments are some of rather than all the embodiments of the present disclosure. All other embodiments obtained by those of ordinary skill in the art based on the embodiments of the present disclosure without inventive effort shall fall within the scope of the present disclosure.

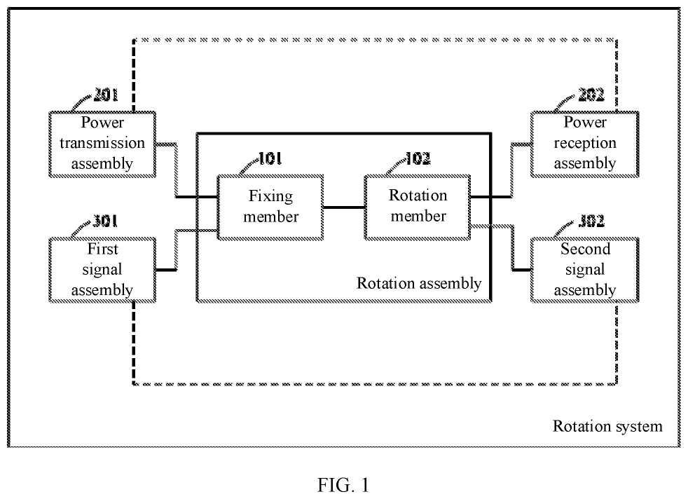

FIG. 1 is a schematic structural diagram of a rotation system according to an embodiment of the present disclosure. As shown in FIG. 1, the rotation system provided by the present disclosure includes a rotation assembly, an electromagnetic induction power supply assembly, and a wireless communication assembly.

The rotation assembly includes a fixing member 101 and a rotation member 102 rotatable relative to the fixing member 101.

The electromagnetic induction power supply assembly includes a power transmission assembly 201 and a power reception assembly 202. The power reception assembly 202 is mounted at the rotation member 102 and rotates with rotation of the rotation member 102. The power transmission assembly 201 is mounted at the fixing member 101 and transmits power to the power reception assembly 202 through electromagnetic induction power supply.

The wireless communication assembly includes a first signal assembly 301 and a second signal assembly 302. The second signal assembly 302 is mounted at the rotation member 102 and rotates with the rotation of the rotation member 102. The first signal assembly 301 is mounted at the fixing member 101 and establishes a wireless communication connection with the second signal assembly 302.

Specifically, the rotation system includes the rotation assembly. Through the rotation assembly, a part of the rotation system connected to the rotation member 102 is rotatable relative to a part of the rotation system connected to the fixing member 101. In some embodiments, the part connected to the rotation member 102 includes the power reception assembly 202 and the second signal assembly 302, and the part connected to the fixing member 101 includes the power transmission assembly 201 and the first signal assembly 301.

The power transmission assembly 201 and the power reception assembly 202 form the electromagnetic induction power supply assembly. As the rotation assembly rotates, the power reception assembly 202 can rotate relative to the transmitting assembly 201. Power can be transmitted between the power transmission assembly 201 and the power reception assembly 202 through the electromagnetic induction power supply. Thus, the power reception assembly 202 can supply power to other components connected to the rotation member 102.

In power supply principle, since the electromagnetic induction power supply is realized by the power transmission assembly 201 and the power reception assembly 202, use of a power supply cable is avoided. Therefore, during the rotation of the rotation assembly, the rotation member 102 can realize 360° omni-directional rotation, with no need of periodic and reverse rotations. On premise of ensuring the power supply for the rotation system, rotation angle is enlarged, rotation flexibility is improved, and application scenario of the rotation system is expanded.

The first signal assembly 301 and the second signal assembly 302 form the wireless communication assembly. As the rotation assembly rotates, the second signal assembly 302 can rotate relative to the first signal assembly 301. The first signal assembly 301 and the second signal assembly 302 can establish the wireless communication connection, and therefore, the first signal assembly 301 and the second signal assembly 302 can transmit data through wireless communication. In some embodiments, the first signal assembly 301 can send data to the second signal assembly 302. Correspondingly, after receiving the data sent by the first signal assembly 301, the second signal assembly 302 can transmit it to other components connected to the rotation member 102 for subsequent processing. Otherwise, the second signal assembly 302 can send data to the first signal assembly 301 similarly. It should be noted that type of data and specific content included in the data are not limited in the present disclosure.

In data transmission principle, since the wireless communication is realized by the first signal assembly 301 and the second signal assembly 302, use of a transmission cables is avoided. Therefore, 360° omni-directional rotation can be realized during the rotation of the rotation assembly, with no need of periodic and reverse rotations. On premise of ensuring the data transmission function for the rotation system, rotation angle is enlarged, rotation flexibility is improved, and application scenario of the rotation system is expanded.

Thus, the rotation system provided by the present disclosure can realize wireless power supply and wireless data transmission respectively through the electromagnetic induction power supply assembly and the wireless communication assembly, which realizes omni-directional rotation, expands the application scenario of the rotation system, and increases service life of the rotation system.

It should be noted that shape and volume of the rotation system are not limited in the present disclosure. Other components included in the rotation system are not limited. Other components respectively connected to the fixing member 101 and the rotation member 102 are not limited.

In some embodiments, the fixing member 101 may include a stator of a motor, and the rotation member 102 may include a rotor of the motor, which drives the power reception assembly 202 to rotate and drives the second signal assembly 302 to rotate.

It should be noted that implementation manner of the motor is not limited in the present disclosure.

In some embodiments, frequency band used for the electromagnetic induction power supply to transmit power is different from the frequency band used for the wireless communication.

Since the frequency band used for the electromagnetic induction power supply to transmit power is different from the frequency band used for the wireless communication, when the wireless power supply and the wireless data transmission are realized at the same time, interference between the two is effectively reduced, and meanwhile, power supply quality and data transmission quality are improved.

It should be noted that the specific frequency band used for the electromagnetic induction power supply to transmit power and the specific frequency band used for the wireless communication are not limited in the present disclosure.

In some embodiments, range of the frequency band used for the electromagnetic induction power supply to transmit power may be 120 KHz to 150 KHz.

In some embodiments, the wireless communication assembly may include at least one of the following: a WIFI communication assembly, a Bluetooth communication assembly, and a near field communication (NFC) assembly.

Types of the wireless communication assembly are different, and the frequency bands used can be different. The specific frequency band used by each type of the wireless communication assembly is not limited in the present disclosure.

In some embodiments, the wireless communication assembly is the WIFI communication assembly.

Since the WIFI communication assembly can communicate with a custom protocol, it is compatible with a TCP/IP protocol and a serial port transparent transmission protocol, and a wireless firmware upgrading can also be carried out, which enhances the applicability of the rotation system.

In some embodiments, when the wireless communication assembly is the WIFI communication assembly, the frequency band used for communication by the WIFI communication assembly may be 5.2 GHz.

By using 5.2 Ghz WIFI chips at both transmitting end and receiving end, near-distance high-speed wireless communication can be realized.

In some embodiments, the power transmission assembly 201 may include a first chip, a first resonant capacitor, and a transmission coil, and the power reception assembly 202 includes a second chip, a second resonant capacitor, and a reception coil.

The first chip outputs a square wave, and the first resonant capacitor and the transmission coil form a resonant circuit. The transmission coil and the reception coil transmit power through the electromagnetic induction power supply. The second resonant capacitor and the reception coil form a resonant circuit, and the second chip outputs a DC voltage.

The following is the description with an example.

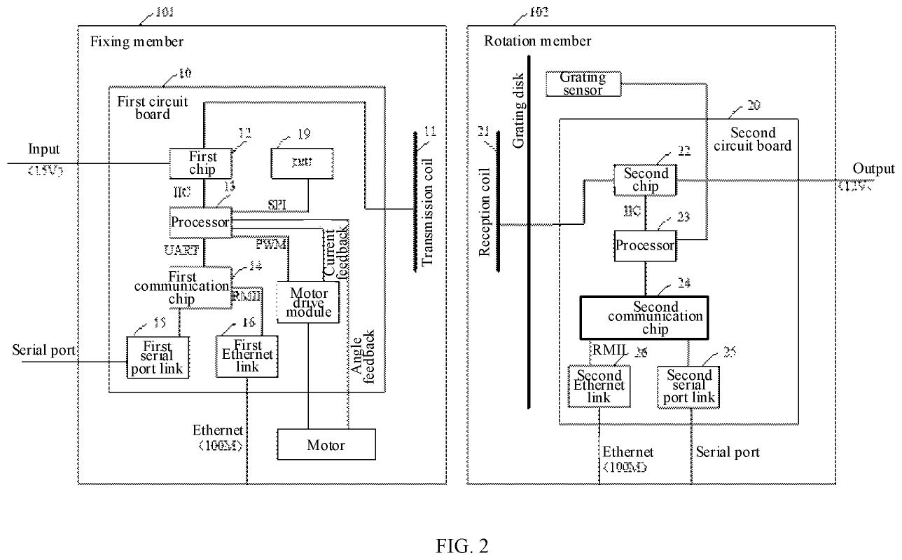

Exemplarily, FIG. 2 is a schematic structural diagram of a circuit in the rotation system according to an embodiment of the present disclosure. It should be noted that the specific numerical values, connection interface types, etc. shown in FIG. 2 are only an example, and do not limit the scope of the present disclosure. In some embodiments, a first chip 12 and a processor 13 are connected through an Inter-Integrated Circuit (IIC). The processor 13 and a first communication chip 14 are connected through a Universal Asynchronous Receiver/Transmitter (UART). The first communication chip 14 and a first Ethernet link 16 are connected through a Reduced Media Independent Interface (RMII).

As shown in FIG. 2, the first chip 12 modulates and outputs a square wave with a certain frequency. In some embodiments, frequency range of the square wave may be 120 KHz to 150 KHz. An AC sine wave is output through a resonant circuit formed by a first resonant capacitor (not shown) and a transmission coil 11. On the side of the rotation member 102, an emitted electromagnetic field forms an induced sinusoidal oscillation on a receiving circuit through a resonant circuit formed by a second resonant capacitor (not shown) and a reception coil 21, and then a second chip 22 outputs a DC voltage through a synchronous rectification technology. Exemplarily, an input voltage of the first chip 12 may be 15V, and an output voltage of the second chip 22 may be 12V or 1.2V.

It should be noted that, capacitance values of the first resonant capacitor and the second resonant capacitor, and inductance values of the transmission coil 11 and the reception coil 21 are not limited in the present disclosure. In some embodiments, the capacitance value of the first resonant capacitor may be 310 nF. The inductance value of the transmission coil 11 may range from 8.5 μH to 11 μH. In some embodiments, the inductance value of the transmission coil 11 may be 10 μH. The inductance value of the reception coil 21 may be 8.2 μH. The capacitance value of the second resonant capacitor may be 500 nF.

In some embodiments, in order to reduce leakage inductance and improve power transmission efficiency through a reasonable magnetic shield design, distance between the transmission coil 11 and the reception coil 21 may range from 1.5 mm to 5 mm.

In some embodiments, the distance between the transmission coil 11 and the reception coil 21 may be 3 mm.

In some embodiments, the transmission coil 11 and the reception coil 21 are disk-shaped.

By setting the transmission coil and the reception coil as disc-shaped, it can be ensured that the power reception assembly and the power transmission assembly can continuously and stably transmit power when the rotation assembly rotates.

In some embodiments, the first chip and a communication chip included in the first signal assembly are integrated on a same circuit board, and the second chip and a communication chip included in the second signal assembly are integrated on a same circuit board.

Referring to FIG. 2, the first chip 12 and the first communication chip 14 included in the first signal assembly are integrated on a first circuit board 10. The second chip 22 and a second communication chip 24 included in the second signal assembly are integrated on a second circuit board 20. Integration level of the chip is improved, and occupied space is reduced.

In some embodiments, the first signal assembly includes the first communication chip and a first antenna, and the second signal assembly includes the second communication chip and a second antenna, where both the first antenna and the second antenna are on-board antennas.

Through the highly integrated communication chips combined with the on-board antennas optimized in a rotation state, fluctuation of signals received after rotation is reduced, and packet loss rate and delay are reduced. Stable communication is realized, and data transmission performance is improved.

In some embodiments, referring to FIG. 2, the rotation system provided by the present disclosure also includes a first serial port link 15 and the first Ethernet link 16 mounted at the fixing member, which are both electrically coupled to the first signal assembly 301.

In some embodiments, the first serial port link 15 is configured to transmit control instructions.

In some embodiments, the first Ethernet link 16 is configured to transmit the following data: image data, and sensing data of a distance sensor.

By setting the first serial port link and the first Ethernet link on the side of the fixing member, data with different bandwidth and real-time requirement are shunted, which improves diversity of network expansion and data transmission modes of the rotation system.

In some embodiments, referring to FIG. 2, the rotation system provided by the present disclosure also includes a second serial port link 25 and a second Ethernet link 26 mounted at the rotation member, which are both electrically coupled to the second signal assembly 302.

In some embodiments, the second serial port link 25 is configured to transmit control instructions.

In some embodiments, the second Ethernet link 26 is configured to transmit the following data: image data, and sensing data of a distance sensor.

By setting the second serial port link and the second Ethernet link on the side of the rotation member, data with different bandwidth and real-time requirement are shunted, which improves diversity of network expansion and data transmission modes of the rotation system.

In some embodiments, the rotation system provided by the present disclosure may also include a processor.

The second signal assembly is configured to receive first time axis information and first motion parameter sent by the first signal assembly. The first motion parameter corresponds to the first time axis information and is used to indicate motion relationship between the first signal assembly and the second signal assembly.

The processor is configured to determine second time axis information corresponding to the first motion parameter in a local second time axis.

The processor is configured to adjust the second time axis according to the first time axis information and the second time axis information, so that the second time axis is synchronized with the first time axis.

In some embodiments, the first signal assembly and the second signal assembly may respectively maintain a time axis locally, and the time axis including a plurality of different moments. In addition, the embodiments are based on the fact that the difference between the motion parameters of the first signal assembly and the second signal assembly is fixed (the difference can be fixed to 0 in some implementation scenarios) when they move relative to a certain physical position. Therefore, the first signal assembly and the second signal assembly also need to record the motion parameters corresponding to each moment (or part of the moment) while maintaining their respective time axes.

That is, the first signal assembly and the second signal assembly respectively maintain a corresponding relationship between the local time axis and the motion parameter. The first signal assembly maintains the corresponding relationship between the first time axis and the first motion parameter, and the second signal assembly maintains the corresponding relationship between the second time axis and the second motion parameter. It should be noted that the first motion parameter and the second motion parameter are the same category or the same type of parameters, that is, if the first motion parameter is a relative rotation angle, the second motion parameter is also a relative rotation angle.

Thus, the embodiments use the relationship between the first motion parameter and the second motion parameter recorded by the first signal assembly and the second signal assembly when moving to the same physical position at the same moment to achieve time synchronization. Due to the addition of a time synchronization mechanism, delay uncertainty introduced by the wireless communication is improved, making it useful in a field sensitive to transmission delay.

It should be noted that “first,” “second,” etc. in some embodiments are not used to limit the number, but are used to distinguish the time axis or so. Thus, in an actual implementation scenario, the first time axis can also be referred to as the second time axis, and the second time axis can also be referred to as the first time axis.

In some embodiments, the motion parameter is used to identify the motion relationship between the first signal assembly and the second signal assembly. Parameters that are specifically recorded are related to the relative motion of the first signal assembly and the second signal assembly when maintenance of the time axis and motion parameter is specifically performed.

The first signal assembly and the second signal assembly can rotate relative to each other, and the first motion parameter includes an absolute rotation angle.

In a possible design, both the first signal assembly and the second signal assembly can rotate, and their rotation shafts are the same, but their rotation speeds or rotation accelerations are different, so that the first signal assembly and the second signal assembly can rotate relative to each other.

In this case, when the first signal assembly and the second signal assembly rotate to the same physical position at the same moment, their rotation shafts are the same, and their absolute rotation angles are the same. In this case, difference between the two time axes can be determined according to first time axis moment and second time axis moment corresponding to the rotation angle, and further, synchronization of the first time axis and the second time axis can be realized.

Or, in another possible design, the first signal assembly cannot rotate, and its position is relatively fixed, while the second signal assembly can rotate. In this case, the second signal assembly can rotate relative to the first signal assembly. In some embodiments, the first signal assembly is a stator and the second signal assembly is a rotor.

In this case, the first motion parameter recorded by the first signal assembly can be the absolute rotation angle of the second signal assembly around the rotation shaft; similarly, the second motion parameter recorded by the second signal assembly is also the absolute rotation angle of the second signal assembly around the same rotation shaft. That is, the physical meaning of the first motion parameter and the second motion parameter are the same, but the first time axis and the second time axis respectively corresponding to the two may be different. Therefore, when the two rotate to the same angle at the same moment, difference between the two time axes can be determined through the corresponding relationship with the first time axis and the second time axis, and further, the second time axis can be adjusted to realize the synchronization of the first time axis and the second time axis.

In any of the designs described above, range of the relative rotation angle of the first signal assembly and the second signal assembly may be greater than or equal to 360 degrees, or less than 360 degrees. This rotatable range also affects the relative motion of the first signal assembly and the second signal assembly.

If the relative rotation angle of the second signal assembly relative to the first signal assembly is greater than or equal to 360 degrees, the rotation range of the second signal assembly relative to the first signal assembly is circular. When the second signal assembly rotates, it can rotate in a single direction relative to the first signal assembly, or it can also rotate in a variable direction relative to the first signal assembly. In addition, it can rotate continuously or intermittently. In some embodiments, the second signal assembly may rotate continuously along a first preset direction relative to the first signal assembly; or the second signal assembly can rotate intermittently relative to the first signal assembly. If it rotates intermittently, it can rotate in the first preset direction (for example, a counterclockwise direction or a clockwise direction) each time, or each rotation can be different, for example, the direction of any two adjacent intermittent rotation is different.

If the relative rotation angle of the second signal assembly relative to the first signal assembly is less than 360 degrees, the rotation range of the second signal assembly relative to the first signal assembly is a sector. In this case, the relative rotation mode that can be achieved includes reciprocating motion of the second signal assembly relative to the first signal assembly.

In addition to the aforementioned absolute rotation angle, the synchronization of the first time axis and the second time axis can also be achieved by using at least one of the following motion parameters as an auxiliary parameter: the relative rotation angle, the rotation speed, and the rotation acceleration.

Based on the designs described above, regardless of the relative motion between the first signal assembly and the second signal assembly, the relative motion relationship between the two can be characterized by the first motion parameter (collected by the first signal assembly) and the second motion parameter (collected by the second signal assembly). When the first signal assembly and the second signal assembly move to the same position at the same moment, the difference between their motion parameters is fixed (the difference may be equal in some scenarios), which can be served as a bridge to achieve the synchronization of the first time axis and the second time axis.

In addition, the present disclosure also provides methods for obtaining the motion parameters described above: the first motion parameter can be sensed and obtained by a first sensor provided at the fixing member, and the second motion parameter can be sensed and obtained by a second sensor provided at the rotation member.

In terms of function, sensor types involved in the present disclosure may include but are not limited to at least one of the following: an angle sensor, a distance sensor, a speed sensor, and an acceleration sensor. The angle sensor is configured to collect and obtain the rotation angle (relative angle or absolute angle is related to zero position, which will be described in detail later), which can be embodied as a grating angle sensor, a Hall angle sensor, etc.

In addition, the aforementioned functional sensors may have different manifestations in specific implementation, which may include, but are not limited to, at least one of the following: a potential sensor, a photoelectric sensor, an electromagnetic sensor, and a force sensor.

It should be noted that in the present disclosure, although the first motion parameter and the second motion parameter are defined as the same type of data, there is no particular limitation on whether the sensors employed to collect these data are the same. In some embodiments, if the first motion parameter and the second motion parameter are absolute rotation angles, the first signal assembly will use the Hall angle sensor arranged thereon to collect the first motion parameter, and the second signal assembly will use the grating angle sensor arranged thereon to collect the second motion parameter. As another example, the first signal assembly and the second signal assembly both use the Hall angle sensors to collect the absolute rotation angles.

In some embodiments, the processor may be a processor provided on the side of the rotation member, exemplary, such as processor 23 in FIG. 2.

In some embodiments, referring to FIG. 2, the rotation system provided by the present disclosure also includes an inertial measurement unit (IMU) 19, which is mounted at the fixing member.

Through the IMU, current pitch angle information of the rotation system can be sensed independently, and the influence of attitude change of the rotation system can be effectively compensated.

In some embodiments, referring to FIG. 2, in the rotation system provided by the present disclosure, a field oriented control (FOC) control technology based on current and angle feedback can be used in motor control part, which can accurately close-loop control the rotation speed and angle current, thereby reducing power consumption and jitter.

The present disclosure provides a rotation system including a rotation assembly, an electromagnetic induction power supply assembly, and a wireless communication assembly. Wireless power supply and wireless data transmission can be realized through the electromagnetic induction power supply assembly and the wireless communication assembly, which realizes omni-directional rotation, expands the application scenario of the rotation system, and improves service life and rotation effect of the rotation system.

The present disclosure also provides a sensor, which includes a rotation system provided in any one of the embodiments shown in FIGS. 1 and 2, and a sensing member mounted at the rotation member.

The sensing member is electrically coupled with the power reception assembly, and is powered by the power reception assembly. The sensing member is electrically coupled with the second signal assembly, and sensing data is transmitted back through the second signal assembly and the first signal assembly.

Thus, in the sensor provided by the present disclosure, the sensing member can be powered in a wireless power supply manner through the electromagnetic induction power supply assembly included in the rotation system, and the data sensed by the sensing member can be transmitted through the wireless communication assembly included in the rotation system. Moreover, the sensing member can rotate in all directions, which expands the application scenario of the rotation system, and improves service life and rotation effect of the rotation system.

In some embodiments, the sensor may include at least one of the following: a laser radar, a microwave radar, an ultrasonic sensor, an infrared sensor, and an image sensor.

One of ordinary skill in the art can understand that all or part of the processes in the method of the embodiments described above can be implemented by a program instructing relevant hardware, and the program can be stored in a computer readable storage medium. When the program is executed, the processes in the method of the embodiments are executed. The storage medium includes a read-only memory (ROM), a random access memory (RAM), a magnetic disk, an optical disk, or another medium that can store program codes.

Finally, it should be noted that the embodiments described above are only used to illustrate the technical solutions of the present disclosure rather than limiting them. Although the present disclosure has been described in detail with reference to all the described embodiments, those of ordinary skill in the art should understand that the technical solutions in all the described embodiments can still be modified, or some or all of the technical features can be equivalently replaced. The modifications or replacements do not cause the essence of the corresponding technical solutions to depart from the scope of the technical solutions in the embodiments of the present disclosure.

What is claimed is:

1. A sensor comprising:
a rotation system including:
a rotation assembly including a fixing member and a rotation member rotatable relative to the fixing member;
an electromagnetic induction power supply assembly including:
a power transmission assembly mounted at the rotation member and configured to rotate with the rotation member; and
a power reception assembly mounted at the fixing member and configured to transmit power to the power reception assembly through electromagnetic induction power supply; and
a wireless communication assembly including:
a first signal assembly mounted at the fixing member; and
a second signal assembly mounted at the rotation member and configured to rotate with the rotation member and to establish a connection with the first signal assembly for wireless communication; and
a sensing member mounted at the rotation member and electrically coupled to the power reception assembly and the second signal assembly, the sensing member being configured to:
be powered by the power reception assembly; and
transmit sensing data through the second signal assembly and the first signal assembly.

2. The sensor of claim 1, wherein a frequency band used for the electromagnetic induction power supply is different from a frequency band used for the wireless communication.

3. The sensor of claim 2, wherein a range of the frequency band used for the electromagnetic induction power supply is 120 KHz to 150 KHz.

4. The sensor of claim 2, wherein the wireless communication assembly includes at least one of a WIFI communication assembly, a Bluetooth communication assembly, or a near field communication (NFC) assembly.

5. The sensor of claim 2, wherein the wireless communication assembly includes a WIFI communication assembly.

6. The sensor of claim 5, wherein the frequency band used for communication by the WIFI communication assembly is 5.2 GHz.

7. The sensor of claim 1, wherein:
the power transmission assembly includes a first chip configured to output a square wave, a first resonant capacitor, and a transmission coil, the first resonant capacitor and the transmission coil forming a first resonant circuit; and
the power reception assembly includes a second chip configured to output a DC voltage, a second resonant capacitor, and a reception coil configured to receive power from the transmission coil through the electromagnetic induction power supply, the second resonant capacitor and the reception coil forming a second resonant circuit.

8. The sensor of claim 7, wherein a distance between the transmission coil and the reception coil ranges from 1.5 mm to 5 mm.

9. The sensor of claim 7, wherein the transmission coil and the reception coil are disk-shaped.

10. The sensor of claim 7, wherein:
the first chip and a communication chip of the first signal assembly are integrated on a first circuit board; and
the second chip and a communication chip of the second signal assembly are integrated on a second circuit board.

11. The sensor of claim 1, wherein:
the first signal assembly includes a first communication chip and a first antenna, the first antenna being a first on-board antenna; and
the second signal assembly includes a second communication chip and a second antenna, the second antenna being a second on-board antenna.

12. The sensor of claim 1, wherein the fixing member includes a stator of a motor, and the rotation member includes a rotor of the motor configured to drive the power reception assembly and the second signal assembly to rotate.

13. The sensor of claim 1, wherein the rotation system further includes a serial port link and an Ethernet link mounted at the fixing member and electrically coupled to the first signal assembly.

14. The sensor of claim 13, wherein the serial port link is configured to transmit control instructions.

15. The sensor of claim 13, wherein the Ethernet link is configured to transmit at least one of image data or sensing data of a distance sensor.

16. The sensor of claim 1, wherein the rotation system further includes a serial port link and an Ethernet link mounted at the rotation member and electrically coupled to the second signal assembly.

17. The sensor of claim 16, wherein the serial port link is configured to transmit control instructions.

18. The sensor of claim 16, wherein the Ethernet link is configured to transmit at least one of image data or sensing data of a distance sensor.

19. The sensor of claim 1, wherein:
the second signal assembly is configured to receive first time axis information regarding a first time axis and a first motion parameter sent by the first signal assembly, the first motion parameter corresponding to the first time axis information and being configured to indicate motion relationship between the first signal assembly and the second signal assembly; and the rotation system further includes a processor configured to:
determine, in a second time axis, second time axis information corresponding to the first motion parameter; and
adjust the second time axis according to the first time axis information and the second time axis information to synchronize the second time axis with the first time axis.
